(19) United States
(12) Patent Application Publication
(10) Pub. No.: US 2002/0028123 A1
(43) Pub. Date: Mar. 7, 2002

(54) Tool for connecting tow members

(75) Inventors: Hideya Miura, Toyoakeno-shi (JP); Shigeki Hirano, Toyota-shi (JP)

Correspondence Address: KANESAKA AND TAKEUCHI, 1423 Powhatan Street, Alexandria, VA, 22314, US

(73) Assignee: NIFCO INC.

(21) Appl. No.: 09/946,520

(22) Filed: Sep. 6, 2001

(30) Foreign Application Priority Data
Sep. 7, 2000 (JP) 2000-271956

(51) Int. Cl. F16B 19/00

(52) U.S. Cl. 411/508

(57) ABSTRACT

A tool for connecting two members includes a head part to be connected to a first member, and a leg part extending from the head part to be connected to an attachment hole in a second member. The leg part includes at least one coupling bump forming on the leg part an enlarged-diameter part larger than a diameter of the attachment hole on the second member, and a gap formed along a central axis of the leg part for allowing the at least one coupling part to bend inward when compressed. The coupling bump has a side surface extending along the central axis of the leg part. When the leg part is inserted into the attachment hole, the coupling bump is elastically bent inwardly to pass the attachment hole and is returned to an original shape at a position where the leg part is completely inserted into the attachment hole to thereby engage the second member.

### BACKGROUND OF THE INVENTION AND RELATED ART STATEMENT

The invention relates to an improvement of a connecting tool that has a head part to be attached to a first member and a leg part to be connected to a second member, and is used for accomplishing connection of the first member and the second member.

There is a shaft-shaped connecting tool having a head part 100 and a leg part 200 extending in the direction of the central axis for connecting two members together by coupling the head part 100 to an attachment part formed on the first member and inserting the leg part 200 into an attachment hole opened in the second member (Japanese Design Registration No. 916156, and FIG. 9 and FIG. 10).

Such connecting tool has trenches 201 extending along the projection direction of the leg part 200, and it is attached to the second member by inserting the leg part 200 into the attachment hole, causing a part of the leg part 200 once to be bent inward elastically using this trench 201 and then letting it recoil, and coupling a coupling bump 202 formed on the leg part 200 to the attachment hole.

Thus, in such connecting tool, from the viewpoint of being able to smoothly accomplish the attachment operation of the connecting tool to the second member, it is desired that the force of insertion should not be made unnecessarily great in inserting the leg part 200 into the attachment hole.

If the amount of protrusion of the coupling bump 202 is made smaller, the thickest part of leg part 200 on which the coupling bump 202 is provided becomes more easily bent in insertion of the leg part 200 into the attachment hole. However, if this amount of protrusion is simply made smaller, the surface area of a coupling surface 202a of the coupling bump 202 with respect to the attachment hole, more specifically, the hole edge of the attachment hole on the far side of insertion of the leg part 200, no longer can be sufficiently formed.

Therefore, an object of the invention is to provide a tool for connecting two members, wherein a force of insertion of a leg part with respect to an attachment hole in which the leg part is inserted is reduced without reducing a surface area of a coupling surface of a coupling bump, which is provided on the leg part, with respect to the attachment hole.

Further objects and advantages thereof are apparent from the following description of the invention.

### SUMMARY OF THE INVENTION

In order to achieve the objects, in the first aspect of the invention, a tool for connecting two members is provided with the constitution in (1)-(4) below:

(1) the tool is a shaft-shaped connecting tool that has a head part and a leg part extending in the direction of the central axis thereof and connects two members together by attaching the head part to an attachment part formed on a first member and inserting the leg part into an attachment hole opened in a second member,

(2) the leg part comprises a coupling bump that forms on the leg part an enlarged-diameter part that is somewhat larger than the hole diameter of the attachment hole on the second member, and a gap allowing bending inward that is formed along the central axis, and

(3) the leg part is attached to the second member by elastically narrowing the leg part such that the leg part passes the position where the enlarged-diameter part is provided using the gap allowing bending and enters into the attachment hole, and by coupling the coupling bump to the attachment hole by recoiling of the leg part at the position where the leg part is completely inserted into the attachment hole,

(4) moreover, the coupling bump of the leg part has a top, i.e. side, end surface that is long in the direction of the central axis.

By such constitution, because the coupling bump has a top end surface that continues lengthwise in the direction of the central axis, during insertion of the leg part into the attachment hole, the enlarged-diameter part which is formed by the coupling bump can be made more easily narrowed elastically to the extent possible by using the gap allowing bending.

That is, in case, by a stroke of the top end surface, i.e. side surface of the shaft, of the coupling bump between the tip side and the base side of the leg part, inward force is applied to the top end surface on the tip side, the coupling part can be easily narrowed elastically with the base side as a fulcrum. Thus, in insertion of the leg part into the attachment hole, the coupling bump can easily ride past the hole edge on the front side of insertion in the attachment hole.

As a result of this, by such constitution, the force of insertion in insertion of the leg part into the attachment hole can be reduced to a suitable extent without reducing the amount of protrusion of the coupling bump, that is, the surface area of the coupling surface of the coupling bump, and the operation of attachment of the connecting tool to the second member can be accomplished more smoothly.

Also, in the second aspect of the invention, the leg part in the tool for connecting two members described in the first aspect is constituted such that it is inserted into the attachment hole of the second member which forms a circular shape, and the top end surface of the coupling bump on this leg part is constituted such that it becomes a curved surface that is curved following the arc of a virtual circle in the direction surrounding the central axis of the connecting tool. Moreover the diameter of this virtual circle is constituted to be smaller than the diameter of the attachment hole of the second member.

By such constitution, the top end surface of the coupling bump is difficult to entirely contact with the hole edge of the attachment hole or the inner surface of the hole accompanying insertion of the leg part into the attachment hole, and the force of insertion of the leg part into the attachment hole can be reduced as compared to the case when the insertion is performed in a state in which the top end surface contacts such hole edge or the inner surface of the hole across a wide range.

### BRIEF DESCRIPTION OF THE DRAWINGS

FIG. 1 is a partially cut side view taken along line 1-1 in FIG. 3 of a connecting tool;

FIG. 2 is a partially cut side view taken along line 2-2 in FIG. 3 of the connecting tool;

FIG. 3 is a plan view of the connecting tool;

FIG. 4 is a bottom view of the connecting tool;

FIG. 5 is a sectional view of a leg part taken along line 5-5 in FIG. 3;

FIG. 6 is a side view of the connecting tool in a using condition;

FIG. 7 is a sectional view taken along line 7-7 in FIG. 1;

FIG. 8 is an enlarged sectional view of the essential component of the connecting tool, i.e. upper right part in FIG. 7;

FIG. 9 is a side view showing the prior art; and

FIG. 10 is a side view showing the prior art from a direction different from FIG. 9.

### DETAILED DESCRIPTION OF PREFERRED EMBODIMENTS

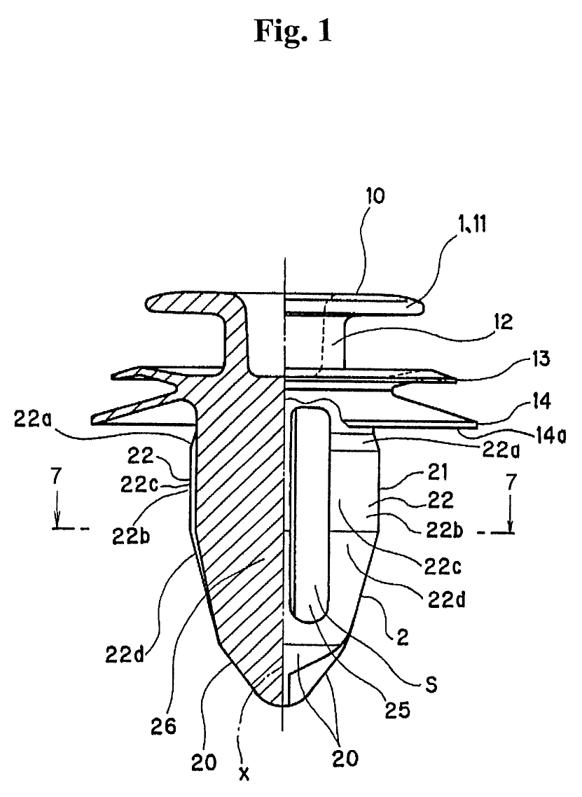

Below, a typical embodiment of this invention is explained based on FIG. 1 through FIG. 8.

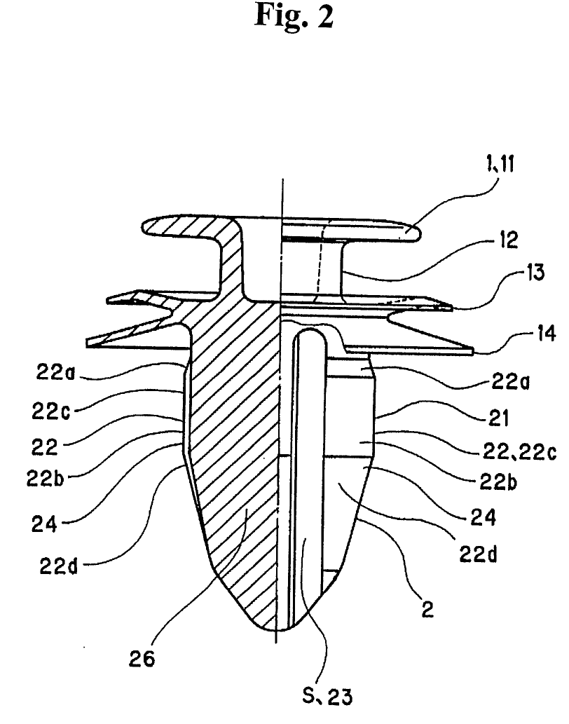

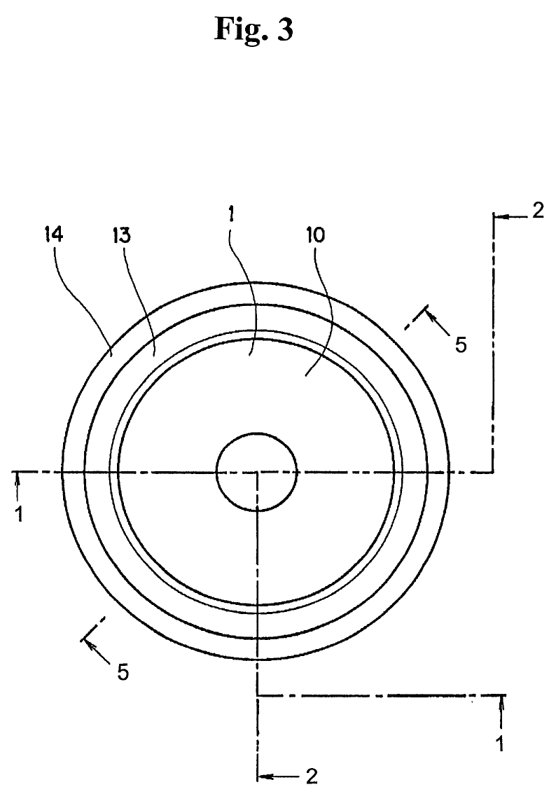

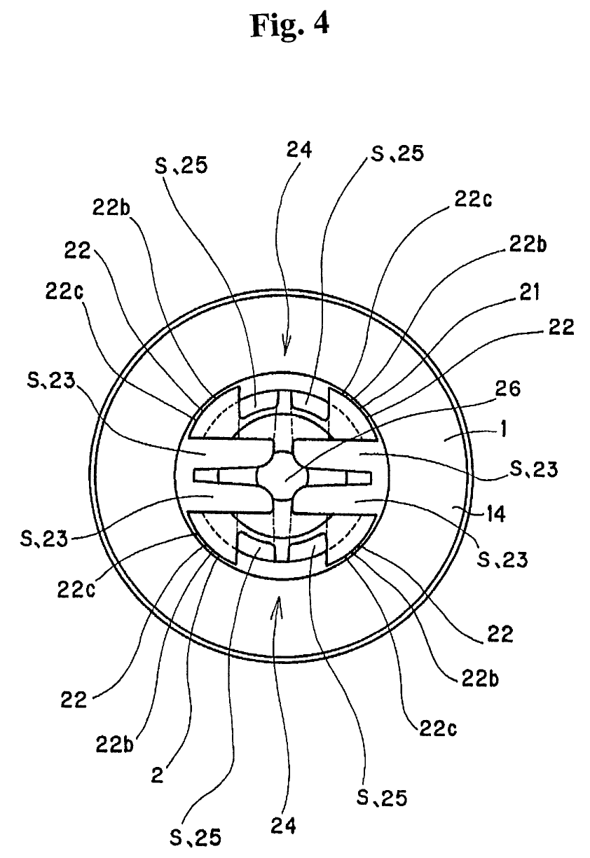

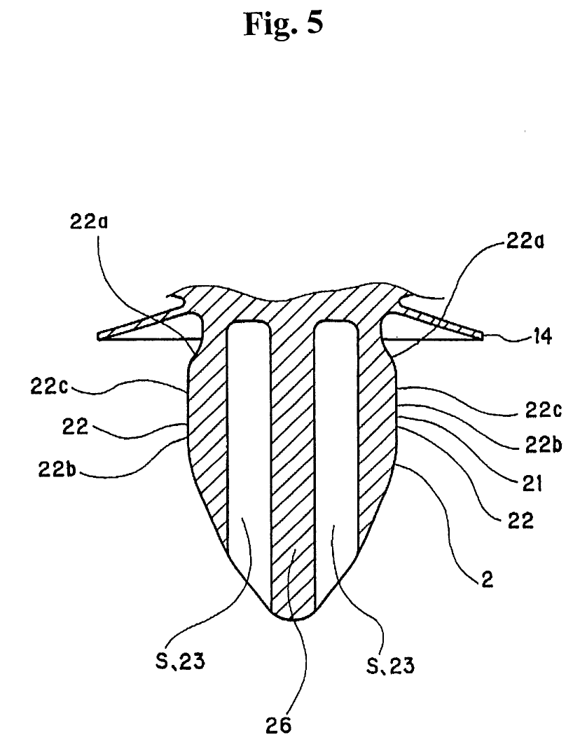

Here, FIG. 1 and FIG. 2 show a connecting tool pertaining to the embodiment from the side in a state in which one side is cut away along the central axis x. Relative to FIG. 1, FIG. 2 shows the connecting tool in a state in which the connecting tool is viewed from a direction shifted 90 degrees from the direction in FIG. 1. Also, FIG. 3 and FIG. 4 show such connecting tool viewed from the side of a head part 1 and viewed from a leg part 2, respectively. Also, FIG. 5 shows mainly the leg part 2 of the connecting tool in section in a direction following the central axis x.

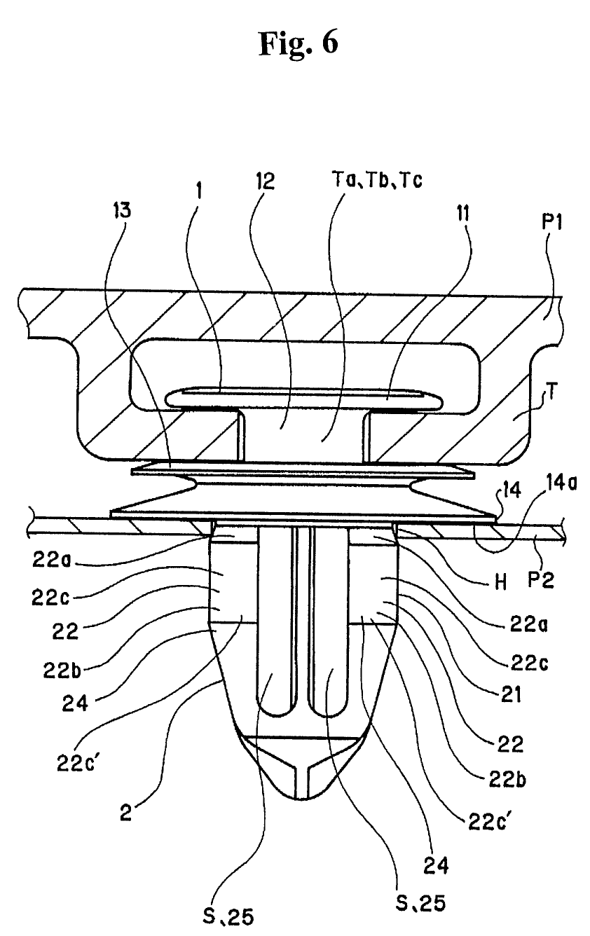

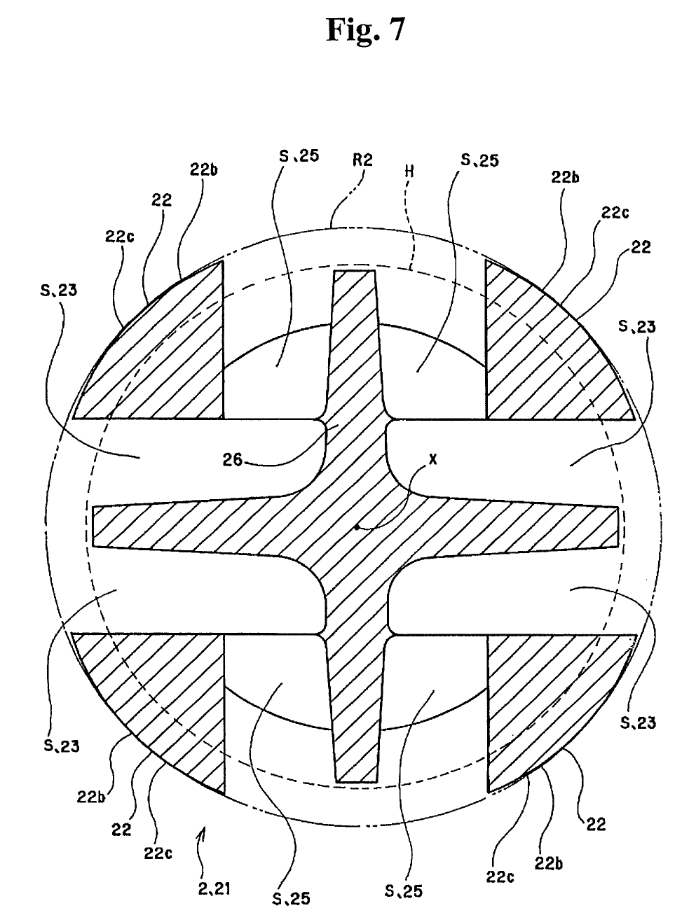

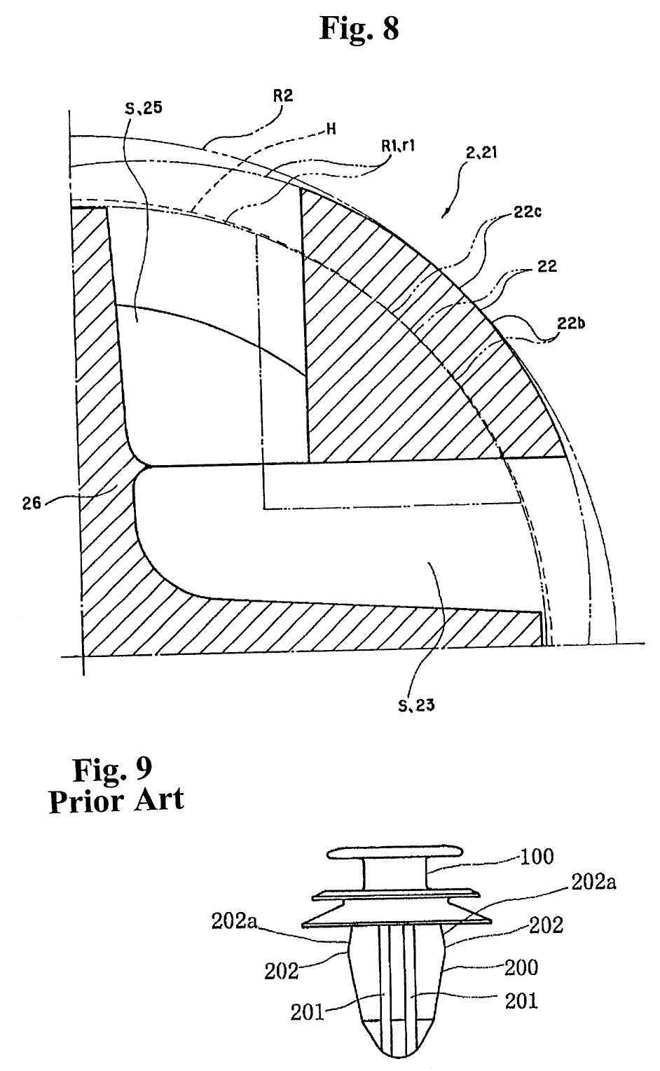

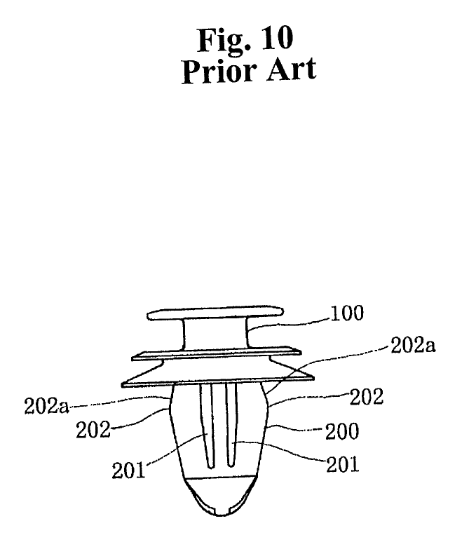

FIG. 6 shows the state in which a first member P1 and a second member P2 are connected together by the connecting tool viewed from the side. Also, FIG. 7 shows an enlarged-diameter part 21 in the leg part 2 of the connecting tool in section in a direction orthogonal to the central axis x. Furthermore, FIG. 8 enlarges the upper right part of FIG. 7, and shows with doubledotted lines an outline of the sectional shape of one of coupling parts 22b formed on the leg part 2 which was bent inward by an attachment hole H of the second member P2, in the state in which the leg part 2 began to be inserted into the attachment hole H. In FIG. 8, the outline of the attachment hole H is shown with dashed lines.

The tool for connecting two members pertaining to this embodiment is a shaft-shaped connecting tool having the head part 1 which is attached to the first member P1, and the leg part 2 which is attached to the second member P2. It is used in order to accomplish connection of the first member P1 and second member P2 via the connecting tool.

Specifically, such connecting tool is provided with the has head part 1 and the leg part 2 extending in the direction of the central axis x. Also, it is constituted so as to connect the two members P1, P2 together by coupling the head part 1 to an attachment part T formed on the first member P1 and inserting the leg part 2 into an attachment hole H opened in the second member P2.

Such head part 1 has a reduced-diameter part 12 between a top end 10 of the head part 1 and the leg part 2. In this embodiment, such head part 1 has a disk-shaped top end plate 11 formed with the central axis x of the shaft-shaped connecting tool as the center of the circle, and an intermediate flange 13 having a gap with this top end plate 11 and projecting outward so as to surround the central axis x. A reduced-diameter part 12 is formed between this top end plate 11 and the intermediate flange 13. Such reduced-diameter part 12 is formed to have a round columnar external shape with the central axis x as the central.

Also, in this embodiment, the reduced-diameter part 12 of such head part 1 is inserted into an insertion hole Ta which is 10 formed on the attachment part T of the first member P1 and receives that reduced-diameter part 12 from a direction intersecting with the central axis x of the connecting tool, whereby the head part 1 is coupled to the first member P1.

Typically, the insertion hole Ta formed on the attachment part T of the first member P1 is constituted as a ball socket Tb having a large-diameter hole part (not illustrated) with a size for receiving the upper end plate 11 of the head part 1, and a small-diameter hole part Tc communicating with this large-diameter hole part. The part Tc is smaller than the top end plate 11 and receives the reduced-diameter part 12. That is, the top end plate 11 of the head part 1 is inserted into the large-diameter hole part in the ball socket Tb, and then the reduced-diameter part 12 of the head part 1 is inserted into the small-diameter hole part Tc of this ball socket Tb, whereby the head part 1 of the connecting tool can be attached to the attachment part T such that the top end plate 11 does not come out from the ball socket Tb in this small-diameter hole part Tc.

Meanwhile, the leg part 2 is constituted to have coupling bumps 22, and a gap S. Each coupling bump 22 has an inclined surface 20 which becomes narrower toward the tip such that the leg part 2 is easily inserted by the tip into the attachment hole H opened in the second member P2, and an enlarged-diameter part 21 which is somewhat larger than the hole diameter of the attachment hole H of the second member P2. The gap S allowing bending is formed along the central axis of the connecting tool, that is, the central axis of such leg part 2.

In this embodiment, a lower flange 14 which projects outward so as to surround the central axis x is formed in the position of connection between such leg part 2 and the head part 1 such that a gap is opened with the intermediate flange 13. Also, such lower flange 14 is constituted to a size that does not enter into the attachment hole H.

Also, the leg part 2 is constituted so as to be attached to the second member P2 by once elastically narrowing the leg part 2 accompanying the insertion of this leg part 2 into the attachment hole H such that the leg part 2 passes the position where the enlarged-diameter part 21 is provided by using the gap S allowing bending and enters into the attachment hole H, and by coupling the coupling bump 22 to the attachment hole H by subsequent recoiling or returning of the leg part 2 at the position where the leg part 2 is completely inserted into the attachment hole H.

That is, in this embodiment, it is made such that the leg part 2 can be inserted into the attachment hole H up to the position where at least one part of the surface of the lower flange 14 facing the tip side of leg part 2 is pushed against the surface that surrounds the hole edge of the attachment hole H on the front side of insertion into the attachment hole H. This position is taken as the position where the leg part 2 is completely inserted into the attachment hole H, and the coupling surface 22a facing the side of the lower flange 14 on the coupling bump 22 can be coupled at this position of complete insertion by recoiling of the leg part 2 to the hole edge of the attachment hole H on the far side of insertion of the attachment hole H (FIG. 6).

In this embodiment, the lower flange 14 is constituted so as be inclined toward the direction gradually approaching the 10 tip side of the leg part 2 as it goes toward its projecting end 14a. Also, the gap surrounding the central axis x of the coupling tool between the projecting end 14a of this lower flange 14 and the position of coupling of the coupling bump 22 on the hole edge of the attachment hole H is made somewhat smaller than the plate thickness of the second member P2 which is panel shaped.

Thus, the leg part 2 can be attached to the second member P2 in a manner that does not rattle in the state in which such lower flange 14 is somewhat deformed elastically toward the direction relaxing its inclination and the lower flange 14 is pressed against the plate surface of second member P2, and the hole opening on the front side of insertion of the attachment hole H is tightly covered by the lower flange 14. From the viewpoint of making it more easily adaptable to some change of the plate thickness of the second member P2, it is preferable to assure that the amount of deformation capability of such lower flange 14 be made greater by making the inclination of the plate surface of such lower flange 14 toward the central axis x greater.

Also, in this embodiment, it is made such that the gap S allowing bending is first formed by two or more trenches 23, extending from the tip of the leg part 2 to the base of that leg part 2.

Specifically, in this embodiment, it is made such that two trenches 23 which extend straight across from the tip of the leg part 2 to the base of the leg part 2 respectively are formed with opening intervals on both sides in the diametric direction of the leg part 2, and such leg part 2 has four of such trenches 23. Each trench 23 is formed so as to have substantially the same width and the same depth, and the trench end on the tip side of the leg part 2 is opened outward at the tip of the leg part 2.

Also, in this embodiment, this leg part 2 is divided left and right by the trenches 23 formed respectively on both sides in the diametric direction of the leg part 2.

Also, in this embodiment, it is constituted such that two long and slender holes 25 extending along the central axis x of the leg part 2 respectively are formed with intervals on the places 24 partitioned by the two trenches 23 which are formed on both sides in the diametric direction of such leg part 2. The coupling bumps 22 are formed on both sides sandwiching these two holes 25.

Also, in this embodiment, by two trenches 23 formed on both sides in the diametric direction of the leg part 2 and two holes 25 formed respectively on the place 24 divided by the two trenches 23 in this manner, a coupling part 22b having the coupling bump 22 is formed in each of four places surrounding the central axis x of the leg part 2.

In this embodiment, the hole 25 forming the coupling part 22b together with the trench 23 is formed so as to connect through to the neighboring trench 23 in the side wall of the trench 23, and the hole 25 is made hollow from a direction substantially 90 degrees different from the direction of hollowing of the trench 23. Thus, each of the coupling parts 22b is connected to a core 26 of the leg part 2 only at the tip side and the base side of the leg part 2.

Also, each coupling part 22b having the coupling bump 22 constituted in this manner has a top end surface, i.e. side surface, 22c of the coupling bump 22 which continues lengthwise in the direction of the central axis x.

Also, each coupling part 22b has a guide surface 22d which is inclined toward the direction gradually narrowing the leg part 2 as it goes from the top end surface 22c of such coupling bump 22 to the tip of the leg part 2, and is also formed to have the coupling surface 22a on the side opposite the guide surface 22d sandwiching this top end surface 22c.

In this embodiment, such coupling surface 22a also is constituted so as to be inclined spreading outward toward the side of the top end surface 22c from the base of the leg part 2, and is made such that, even when the thickness of the second member P2 having the attachment hole H changes slightly, the coupling surface 22a can be properly coupled to the hole edge on the far side of insertion in the attachment hole H by insertion of the leg part 2 into this attachment hole H.

Also, it is made such that each coupling part 22b having the coupling bump 22 is bent inward smoothly with the trench 23 and the hole 25 as gaps S allowing bending, following the inclination of the guide surface 22d, while the guide surface 22d is made to contact with the hole edge of the attachment hole H or the inner surface of the hole, accompanying insertion of the leg part 2 into the attachment hole H.

As the width of such hole 25 is made wider, the surface area of each coupling part 22b of the leg part 2 can be reduced in each location in the direction of the central axis, such that each coupling part 22b having the coupling part 22 can be more easily bent inward.

Specifically, in this embodiment, four coupling parts 22b having the coupling bumps 22 are formed to have substantially the equal intervals around the central axis x in the leg part 2. Also, each coupling part 22b likewise has the top end surface 22c of the coupling bump 22 which continues lengthwise along the central axis x. Also, each coupling part 22b likewise is made as a curved surface that is curved along an arc r1 of a virtual circles R1 of the same size around the central axis x.

Also, in this embodiment, it is made such that the attachment hole H of the second member P2 in which the leg part 2 is inserted is made as a circular hole, and the diameter of a virtual circle R2 having virtual lines respectively passing through the central axis x and top end surfaces 22c of two of the coupling parts 22b in opposite positions sandwiching the central axis x as the diameter is larger than the diameter of this attachment hole H.

In this example, because the coupling bump 22 has the top end surface 22c which extends lengthwise along the central axis x, during the insertion of the leg part 2 into the attachment hole H, the enlarged-diameter part 21 which is formed by each coupling part 22b having the coupling bump 22 can be made easily narrowed inward elastically by using the trench 23 and hole 25 as gaps S allowing bending.

That is, in this embodiment, by a stroke or length of the top end surface 22c of the coupling bump 22 between the tip side and the base side of the leg part 2, when an inward force is applied to the top end surface, i.e. side surface, 22c on the tip side, the coupling part 22b can be easily narrowed elastically with the base side as a fulcrum. Thus, in the insertion of the leg part 2 into the attachment hole H, the coupling bump 22 can easily ride past the hole edge on the front side of insertion in the attachment hole H.

As a result of this, in this embodiment, the force of insertion in inserting the leg part 2 into the attachment hole H can be reduced to a suitable extent and it can be made such that the operation of the attachment of the connecting tool to the second member P2 can be accomplished more smoothly.

Also, in this embodiment, it is made such that the diameter of the virtual circle R1, the arc r1 of which is made to follow, is smaller than the diameter of the attachment hole H (FIG. 8).

As a result, in this embodiment, the top end surface 22c of the coupling bump 22 is difficult to entirely contact with the hole edge of attachment hole H or the inner surface of the hole accompanying insertion of the leg part 2 into the attachment hole H, and the force of insertion of the leg part 2 into the attachment hole H can be reduced as compared to the situation when the insertion is performed in a state in which the top end surface 22c is made to contact such hole edge or the inner surface of the hole across a wide range.

By the tool for connecting two members pertaining to this invention, the force of insertion of the leg part of the connecting tool on the attachment hole in which the leg part is inserted can be reduced to the extent without reducing the surface area of the coupling surface of the coupling bump, which is provided on the leg part, with respect to the attachment hole.

While the invention has been explained with reference to the specific embodiment of the invention, the explanation is illustrative, and the invention is limited only by the appended claims.

What is claimed is:

1. A tool for connecting two members, comprising:
a head part to be connected to a first member, and
a leg part extending from the head part to be connected to an attachment hole in a second member, said leg part including at least one coupling bump forming on the leg part an enlarged diameter part larger than a diameter of the attachment hole on the second member, said coupling bump having a side surface extending along a central axis of the leg part, and a gap formed along the central axis for allowing the at least one coupling part to bend inward when compressed so that when the leg part is inserted into the attachment hole, the coupling bump is bent elastically inwardly to pass the attachment hole and is returned to an original shape at a position where the leg part is completely inserted into the attachment hole to thereby engage the second member.

2. A tool for connecting two members according to claim 1, wherein said side surface of the coupling bump is curved to have a curved portion around the central axis of the connecting tool.

3. A tool for connecting two members according to claim 2, wherein said coupling bump includes a coupling surface formed near the head part to extend toward the central axis from the side surface to be able to engage the attachment hole, and a tapered guide surface extending from the side surface toward a tip of the leg part.

4. A tool for connecting two members according to claim 3, wherein at least two coupling bumps are formed symmetrically relative to the central axis of the connecting tool.

5. A tool for connecting two members according to claim 4, wherein said leg part includes two pairs of grooves extending along the central axis, each pair being spaced apart from each other and facing the other pair with a space therebetween.

6. A tool for connecting two members according to claim 5, wherein said leg part further includes two pairs of elongated holes extending along the central axis, each pair being spaced apart from each other and facing the other pair with a space therebetween, said elongated holes communicating with the grooves to thereby form four coupling bumps divided by the elongated holes and grooves.

7. A tool for connecting two members according to claim 6, wherein said leg part further includes a central portion surrounded by the grooves and elongated holes, said central portion having a cross shape in section perpendicular to the central axis.
